(19) United States
(12) Patent Application Publication
(10) Pub. No.: US 2025/0091068 A1
(43) Pub. Date: Mar. 20, 2025

(54) Liquid Sprayer

(71) Applicant: Robert Bosch GmbH, Stuttgart (DE)

(72) Inventors: Tiffany Kurko, Chicago, IL (US); Robert Lewton, Arlington Heights, IL (US)

(21) Appl. No.: 18/883,105

(22) Filed: Sep. 12, 2024

Related U.S. Application Data
(60) Provisional application No. 63/538,333, filed on Sep. 14, 2023.

(51) Int. Cl. B05B 9/08; B05B 12/08

(52) U.S. Cl. CPC B05B 9/0861; B05B 12/085

(57) ABSTRACT

A portable, battery-powered liquid sprayer includes a supply tank assembly, a base assembly, and a wand. The supply tank assembly holds a liquid to be sprayed. The base assembly is selectively coupled to the supply tank assembly. The base assembly receives and supports a motor, a pump that is driven by the motor, and a rechargeable battery that powers the motor. Based on a signal provided by a pressure switch that detects an outlet pressure of the pump, the motor drives the pump to drive the liquid from the supply tank assembly and to eject the liquid from the hose. The battery is removably coupled to the base assembly and is operable to supply power to the motor. A wand is connected to an outlet of the pump via a flexible hose whereby the wand is in fluid communication with the supply tank assembly.

### BACKGROUND

Hand-held (e.g., portable), powered liquid sprayers are used to spray or otherwise discharge a liquid agent onto an object or a surface. Powered liquid sprayers may include a liquid supply tank that stores liquid to be sprayed and a power unit that receives liquid from the tank and directs the fluid to a spray wand that terminates in a nozzle. Sprayers typically transfer the liquid from the tank to the object using a pump, a vacuum, or any other device that can create a pressure differential between the reservoir and a region outside the reservoir, thereby urging the liquid to the region outside the reservoir. The liquid can be any of any type including water, pesticides, fertilizers, insecticide, termiticide, germicide, or other chemical agents.

### SUMMARY

A portable, battery-powered liquid sprayer includes a supply tank assembly, a base assembly, and a wand. The supply tank assembly holds a liquid to be sprayed. The base assembly is selectively and detachably coupled to the supply tank assembly. The base assembly encloses and supports a motor and a pump. The motor receives power from the battery and drives the pump to supply water from the tank to a hand-held applicator such as a wand. A pressure sensor is used to detect the pressure of the fluid supply line that connects the pump to the wand, and a controller selectively drives the motor (and thus the pump) to transfer the liquid from the supply tank assembly and to eject the liquid from the hose based on a pressure detected by the pressure sensor. The battery is removably coupled to the base assembly and is operable to supply power to the motor. The wand is movable relative to the base assembly and is in fluid communication with the supply tank assembly. The wand itself is removable and includes a nozzle. In some embodiments, the sprayer may include a frame connected to the base that can be configured for a backpack, while in other embodiments, wheels may be connected to the base whereby the spray has a cart configuration. The tank is also detachable. Having a detachable tank allows for less chance of cross-contamination between chemicals, and also allows different sized tanks to be used with the base assembly.

In some aspects, a portable liquid sprayer includes a base assembly configured to be connected to a base fluid outlet line and a supply tank that is configured to store a liquid to be sprayed. The supply tank is detachably coupled to and supported on the base assembly. The base assembly includes a housing, a motor disposed in the housing and a battery disposed in the housing. The battery is configured to supply power to the motor. The base assembly includes a pump disposed in the housing, the pump configured to be driven by the motor and output fluid to the base fluid outlet line via a pump fluid outlet line that is disposed inside the housing. The base assembly includes a pressure sensor configured to detect a fluid pressure of the pump fluid outlet line and output a fluid pressure signal corresponding to the detected fluid pressure. In addition, the base assembly includes a controller that is configured to receive the fluid pressure signal and to activate the motor based on the detected fluid pressure.

In some embodiments, the sprayer includes a base fluid outlet line having a first end that connects to the base assembly and a second end that is opposed to and spaced apart from the first end. The second end of the base fluid outlet line comprises a wand assembly that receives fluid from the supply tank via the base fluid outlet line and is configured to selectively spray the received fluid.

In some embodiments, the sprayer includes a base fluid outlet line having a first end that connects to the base assembly and a second end that is opposed to and spaced apart from the first end. The second end of the base fluid outlet line terminates in a quick connect mechanical fluid connector.

In some embodiments, the housing includes an opening and a fitting mounted in the opening, the fitting configured to provide a fluid connection between the base fluid outlet line and the pump outlet line.

In some embodiments, the controller is configured to receive the fluid pressure signal from the pressure sensor. When the detected fluid pressure is less that a predetermined pressure, the controller permits power to be supplied to the motor and the pump is driven by the motor. In addition, when the detected fluid pressure is greater than the predetermined pressure, the controller prevents power from being supplied to the motor and the pump is not driven by the motor.

In some embodiments, the supply tank is connected to the pump via a pump fluid inlet line that is disposed in the base assembly.

In some embodiments, the battery is removably coupled to the base assembly.

In some embodiments, the sprayer is configured so that a user-operated power switch mounted on an outer surface of the housing determines a connection between the motor and the battery, and when the power switch is in an on position, the motor is operable to drive the pump based on the detected fluid pressure, and when the power switch is in an off position, the motor is not operable.

In some embodiments, the spryer includes a display. The controller is configured to monitor the state of charge of the battery, and to output a control signal to the display corresponding to the state of charge of the battery, and the display is configured to display a representation of the state of charge of the battery based on the control signal.

In some embodiments, the spryer includes a selector device that is mounted on the housing so as to permit manipulation by a user of the sprayer. The selector device is electrically connected to the controller, and the controller is configured to control the speed of the motor based on a configuration of the selector device.

In some embodiments, the base assembly comprises a back frame that is connected to the housing, the back frame configured to convey the sprayer between use locations.

In some embodiments, the back frame is configured to be converted between a first use mode and a second use mode. The first use mode includes a harness configuration that can be worn on a body of a user of the sprayer, and the second use mode includes a wheeled cart configuration that can be pulled or pushed along a ground surface by a user of the sprayer.

### BRIEF DESCRIPTION OF THE FIGURES

FIG. 1 is a front perspective view of a liquid sprayer.

FIG. 2 is a rear perspective view of the sprayer.

FIG. 3 is an exploded rear perspective view of the sprayer.

FIG. 4 is a perspective view of certain of the internal elements of the sprayer base assembly, with the reservoir of the supply tank represented by broken lines.

FIG. 5 is an exploded front perspective view of the sprayer.

FIG. 6 is a perspective view of certain of the internal elements of the sprayer base assembly, with housing of the base assembly represented by broken lines.

FIG. 7 is a schematic illustration of the components of the sprayer in which electrical connections are illustrated with solid arrows and fluid connections are illustrated with open arrows.

FIG. 8 is a schematic illustration of the base outlet fluid line of the base assembly illustrating the presence of a valve disposed inside the hose portion of the line.

FIG. 9 is a flow diagram illustrating operation of the sprayer.

FIG. 10 is a rear perspective view of an alternative embodiment sprayer.

FIG. 11 is a rear perspective view an alternative embodiment sprayer.

### DETAILED DESCRIPTION

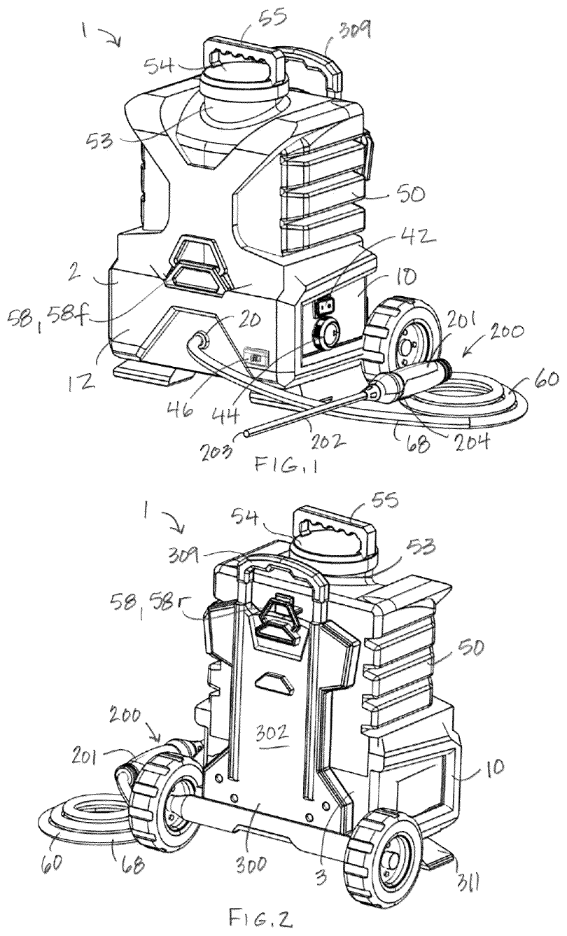

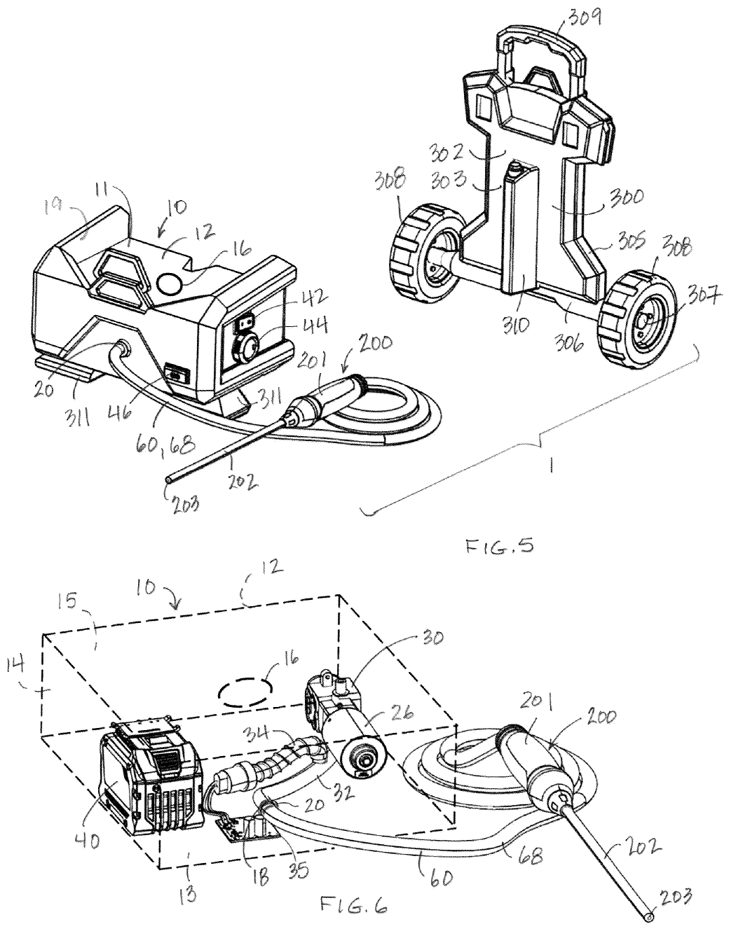

Referring to FIGS. 1-4, a portable, battery-powered liquid sprayer 1 includes a supply tank 50 that is detachably mounted on an upper surface of a base assembly 10. The base assembly 10 is configured to support the supply tank 50 and form a sealed fluid connection with the fluid supply tank 50. The base assembly 10 includes a motor 26 and a fluid pump 30 that is driven by the motor 26. The fluid pump 30 receives fluid from the supply tank 50 and delivers it to a base fluid outlet line 60 that is detachably secured to a fitting 20 of the base assembly housing 12. In some embodiments, the base fluid outlet line 60 may be connected to a power tool (not shown), whereby the sprayer 1 may be used, for example, to deliver cooling fluid to a cutting blade of a power tool. In other embodiments, the base fluid outlet line 60 may incorporate a hand-held wand assembly 200 configured to receive fluid and to emit and disburse the fluid as a spray. Details of the base assembly 10, the supply tank 50 and the base fluid outlet line 60 are described in detail below.

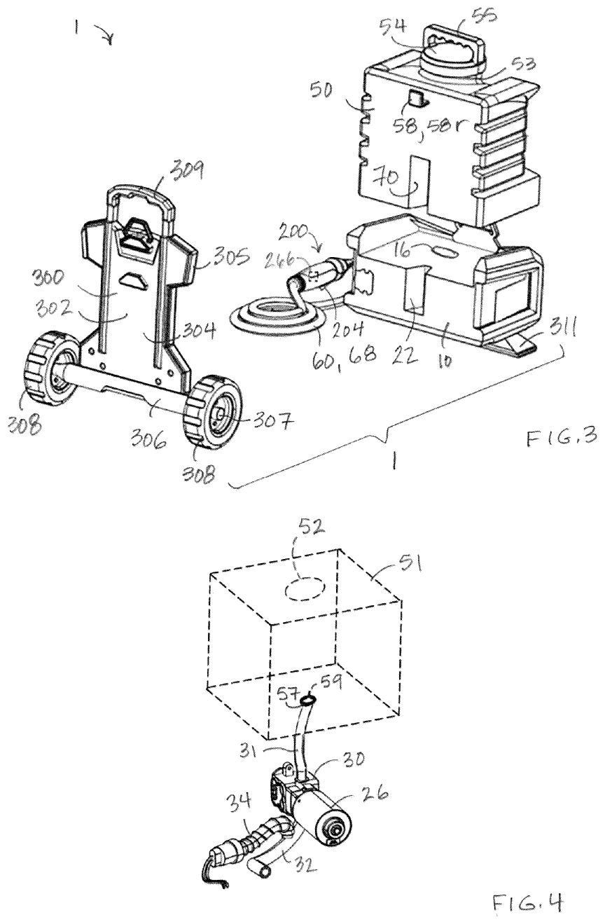

The supply tank 50 is a generally hollow, rigid structure, and an internal space of the supply tank defines a reservoir 51 that receives a liquid to be sprayed. Although the supply tank 50 is illustrated here as having a generally rectangular shape, the supply tank 50 is not limited to any particular shape. The supply tank 50 is detachably coupled to and supported on an upper surface of the base assembly 10. References made herein to a relative direction such as upper, lower, above, below, top, bottom, over, under, front, rear, etc. are made with respect to the orientation of the sprayer 1 as shown in FIGS. 1 and 2 for purposes of description and are not intended to be limiting. The supply tank 50 has a tank outlet opening 59 in a lower surface thereof that permits fluid communication between the reservoir 51 and a pump fluid inlet line 31 that is disposed in the base assembly 10. In particular, a fluid seal 57 exists between the supply tank 50 and the base assembly 10 that provides a sealed connection between the tank outlet opening and the pump fluid inlet line 31. Because the supply tank 50 is detachable, it is possible to substitute one supply tank 10 for another on the base assembly 10. This interchangeability permits different chemicals, each contained in its own supply tank 10, to be used with the same base assembly 10. It also, or alternatively, permits supply tanks 10 of different sizes to be used with the same base assembly 10. In some embodiments, for example where the liquid to be sprayed is a corrosive chemical, the supply tank 10 may be formed of metal. In other embodiments, the supply tank 50 may be formed of plastic.

The supply tank 50 includes a fill opening 52 in an upper surface thereof. The fill opening 52 is surrounded by an upright annular projection 53 having an external thread. A lid 54 having a complementary internal thread may be secured to the projection 53, whereby by the fill opening 52 may be closed in a fluid-tight manner. In the illustrated embodiment, the lid 54 includes a handle 55. When the supply tank 50 is detached from the base assembly 10, the supply tank 50 may be carried by the handle 55.

The supply tank 50 may include features that permit it to be detachably secured to the base assembly 10. For example, in the illustrated embodiment, the supply tank 50 is detachably connected to the base assembly 10 using metal buckles 58. In this example, a buckle 58 is provided on each of the front side 2 and the rear side 3 of the sprayer 1. The front buckle 58f is provided on the sprayer front side 2 at a location near the joint between the supply tank 50 and the base assembly housing 12. One of the male portion or the female portion of the buckle 58f may be provided on the supply tank 50, while the other of the male portion or the female portion of the buckle 58f may be provided on the base assembly housing 12. In addition, a rear buckle 58r is provided on the sprayer rear side 3 at an upper portion of the supply tank 50. One of the male portion or the female portion of the buckle 58r may be provided on the supply tank 50, while the other of the male portion or the female portion of the buckle 58 may be provided on the back frame 300, which is described below. The buckles 58 allow the supply tank 50 to be selectively attached and detached from the base assembly 10 without requiring tools to be used.

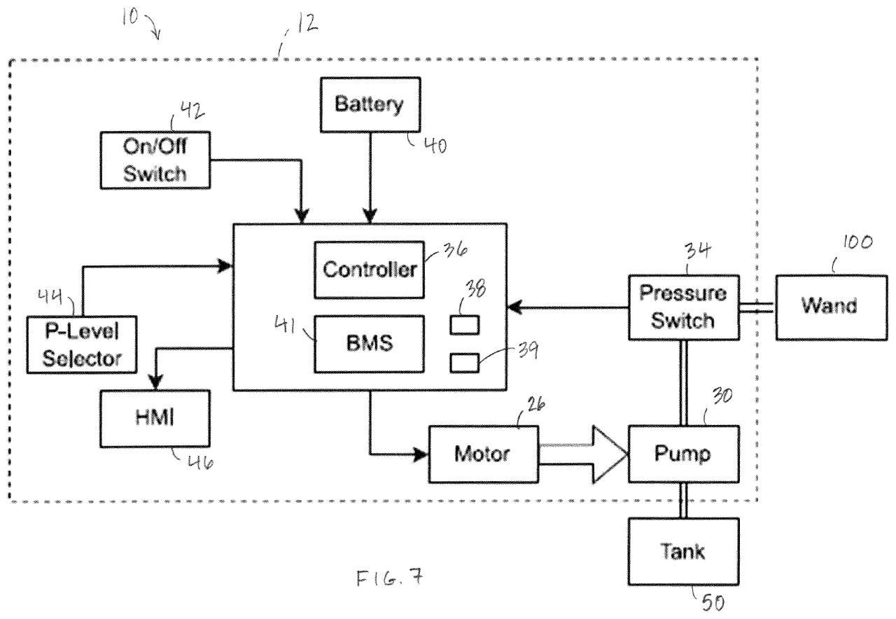

Referring FIGS. 1-2 and 5-7, the base assembly 10 is configured to underlie the supply tank 50 and form a fluid connection with reservoir 51 via the underside of the fluid supply tank 50. The base assembly 10 includes a housing 12 that encloses the working elements of the sprayer 10. The housing 12 may include a base 13, a cover 15 that overlies the base 13, and a sidewall 14 that extends around a periphery of the base 13 and the cover 15, and joins the base 13 to the cover 15.

The upper surface 11 of the base assembly housing 12 (e.g., an outer surface of the cover 15) may include features that enhance proper positioning and/or location of the supply tank 50 relative to the base assembly 10 and/or that facilitate a reliable connection between these structures, including shaped surface structures that are complimentary in shape and or are configured to engage each other. In the illustrated embodiment, the upper surface 11 of the housing 12 includes upright protrusions 19 that extend along a periphery of the housing 12. The upright protrusions 19 and the housing upper surface 11 cooperate to define a tray that receives the lower portion of the supply tank 50 therein.

The cover 15 includes a housing inlet opening 16 that receives a pump fluid inlet line 31. The sidewall 14 includes a housing outlet opening 18 that receives and supports a fitting 20. The fitting 20 is configured to provide a connection between a pump fluid outlet line 32 that is disposed inside the housing 12 to the base fluid outlet line 60 that is disposed outside the housing 12. In some embodiments, the fitting 20 may provide for a threaded connection between the respective lines 32, 60 and the fitting 20. In other embodiments, the fitting 20 may provide for quick connect/disconnect and/or swiveling of pressurized lines. The fitting 20 may be located on the front side 2 of the sprayer 1.

The housing 12 contains the working elements of the sprayer 10, which include the motor 26, the pump 30 that is driven by an output shaft of the motor 26, a pressure sensor 34, a rechargeable battery 40 and a printed circuit board (PCB) 35. The PCB 35 supports a controller 36, a battery monitoring system (BMS) 41 and other ancillary electronic components required for operation of the sprayer 1. In addition, the housing sidewall 14 supports an on/off switch 42 that controls an electrical connection between the battery 40 and the motor 26, a display or human machine interface (HMI) 46, and a fluid pressure level selector 44. In the illustrated embodiment, the fluid pressure level selector 44 is a rotary knob, but the sprayer 1 is not limited to this type of selector.

The motor 26 may be a brushless DC motor and is controlled by the controller 36 via an electrical circuit that includes the on/off switch 42 and the battery 40.

The pump 30 may be double diaphragm pump, which may provide improved longevity in the presence of chemicals than other types of pumps. However, the pump 30 is not limited to being a double diaphragm pump, and the type of pump used may depend on the specific application. The pump 30 is driven by an output shaft of the motor 26. The pump 30 is connected to the tank outlet opening 59 via a pump fluid inlet line 31 whereby the pump 30 is able to draw fluid from the tank reservoir 51. The pump 30 is connected to an interior portion of the fitting 20 via a pump fluid outlet line 32 whereby the pump 30 is able to deliver fluid to the base fluid outlet line 60.

The battery 40 is configured to supply power to the motor 26 and the electronics supported on the PCB 35 including the controller 36 and the BMS 41. In some embodiments, the battery 40 is non-detachable from the housing 12 and may be recharged via a housing plug (not shown). In other embodiments, the battery 40 is detachable from the housing 12 and may be removed from the housing 12 for charging and/or replacement via a door (not shown) provided in the housing 12. The BMS 41 may be configured to monitor the state of charge (SOC) of the battery 40 and provide an SOC signal to the controller 36. In turn, the controller 36 may control the display 46 to provide a representation of the SOC to the user during operation of the sprayer 1. As used herein, the term “battery” refers to a pack of individual cells; however, the monitoring and control functions of the BMS 41 are specifically applied to individual cells, or groups of cells called modules in the overall battery pack assembly.

The pressure sensor 34 is supported in the housing 12 at a location near the pump 30. The pressure sensor 34 is configured to detect a fluid pressure of the pump fluid outlet line 32 and output a fluid pressure signal corresponding to the detected fluid pressure to the controller 36. The controller 36 is configured to receive the fluid pressure signal and to activate the motor 26 based on the detected fluid pressure. The specifics of the operation of the sprayer 1 are described in detail below.

In the illustrated embodiment, the BMS 41 is a software module of the controller 36. The BMS 41 may, for example, monitor the battery, provide battery protection, estimate the battery's operational state, optimize battery performance and/or report operational status of the battery to the controller 36.

The controller 50 is communicatively coupled with the pressure level selector 44 and the display 46. The pressure level selector 44 may be a manually-adjustable mechanical input device such as a rotary switch or a slide switch. The display 46 may be used, for example, to indicate the on/off status of the sprayer 1 and to provide a representation of the state of charge of the battery 40. The display (also referred to as a human-machine interface) 46 may be colored, non-colored (e.g., grayscale), or a combination of both. The display 46 may be implemented as any type of display including LCD, LED, VGA, OLED, SVGA, CRT, or any other alternative configuration known to one of ordinary skill in the art. In some embodiments, the display 46 may provide touch-screen functionality and the pressure level selector may be integrated into the display 46.

The controller 36 may also be communicatively coupled with various operational components of sprayer 1 as well, including, but not limited to, the motor 26 and the pressure sensor 34. As used herein, the term “communicatively coupled” may refer to a direct wired connection via for example conductive signal lines, shared communication busses, or alternatively may refer to a wireless connection. Thus, controller 36 can receive information from these devices and selectively activate and operate the various operational components.

In some embodiments, controller 36 includes one or more memory devices 38 and one or more processors 39. The processors 39 may be any combination of general or special purpose processors, CPUs, or the like that can execute programming instructions or control code associated with operation of the sprayer 1. The memory devices (i.e., memory) 38 may represent random access memory such as DRAM or read only memory such as ROM or FLASH. In some embodiments, the processor 39 executes programming instructions stored in memory 38. The memory 38 may be a separate component from the processor 39 or may be included onboard within the processor 39. Alternatively, the controller 36 may be constructed without using a processor 39, for example, using a combination of discrete analog or digital logic circuitry (such as switches, amplifiers, integrators, comparators, flip-flops, AND gates, and the like) to perform control functionality instead of relying upon software.

In some embodiments, the controller 36 includes a network interface such that the controller 36 can connect to and communicate over one or more networks (not shown). The controller 36 may also include one or more transmitting, receiving, or transceiving components for transmitting and/or receiving communications with other devices communicatively coupled with the sprayer 1. Additionally, or alternatively, the transmitting, receiving, or transceiving components can be located off board controller 36. Generally, the controller 36 may be positioned in any suitable location throughout base assembly 10.

The various functions performed by the controller 36 may be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

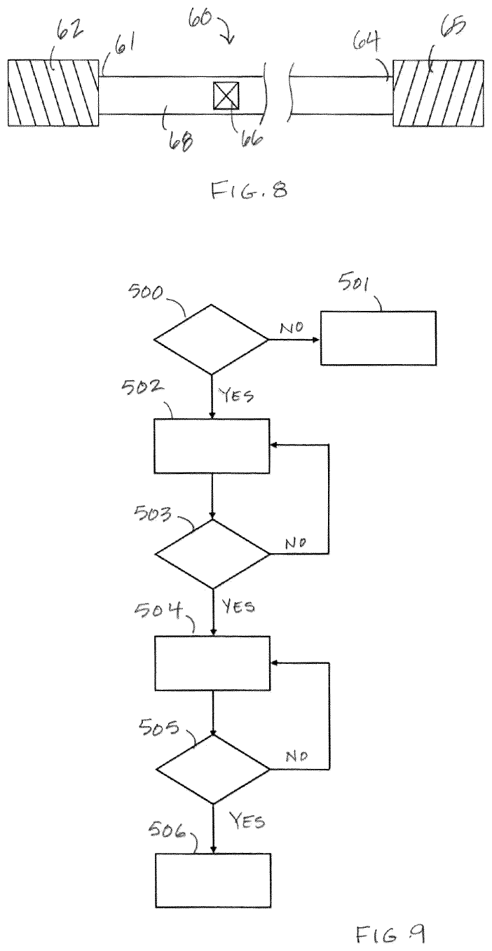

Referring to FIGS. 5-7 and 8, in addition to the base assembly 10 and the supply tank 50, the sprayer 1 also includes a base fluid outlet line 60 that is used by the operator of the sprayer 1 to direct fluid output from the sprayer 1 to the area to be sprayed. The base fluid outlet line 60 includes a first end 61 and a second end 64 that is opposite the first end 61. The first end 61 consists of a connector 62 that is detachably connectable to the outer portion of the fitting 20 provided on the sidewall 14 of the base assembly 10. For example, if the outer portion of the fitting 20 provides an outer thread, the first end 61 including the connector 62 may have an internal thread configured to engage and form a sealed connection with the fitting outer thread.

The base fluid line second end 64 is opposed to and spaced apart from the first end 61 by a hose portion 68. The second end 64 consists of a connector 65 that enables the base fluid outlet line 60 to be detachably connected to an external device such as a wand assembly (shown) or a power tool (not shown). For example, the connector 65 may have an internal or external thread configured to engage and form a sealed connection with a fitting of the external device. In another example, the connector 65 may be configured to engage a high pressure quick connector to permit engagement with a counterpart connector of the external device.

The hose portion 68 may be a flexible tube that is configured to contain pressurized fluid. In addition, the connectors 62, 65 and the hose portion 68 of the base fluid outlet line 60 may be formed of a material or materials that are impervious to chemicals such as, but not limited to, pesticides, herbicides, fungicides, insecticides, fertilizers, and/or concrete-related chemicals such as curing and sealing chemicals, etcher, form oil, muriatic acid, xylene, etcetera.

Referring to FIGS. 1, 3 and 5-6, the sprayer 1 may include a wand assembly 200 that detachably connects to the base fluid outlet line second end 64, receives fluid from the supply tank 50 via the hose portion 68 and is configured to selectively spray the received fluid. The wand assembly 200 includes a handle 201 that is joined to the hose portion 68 and a rigid, tubular wand 202 that protrudes from the handle 201. The wand 202 terminates in a spray nozzle 203 which may be adjustable to permit selection of a spray pattern. The handle 201 is sized and shaped to be gripped by the hand of an operator of the sprayer 1. The handle 201 includes a normally closed fluid control valve 266 and a protruding trigger 204. The trigger 204 is configured to open and/or close the fluid passageway between the hose portion 68 and the nozzle 203 via the control valve 266. For example, the operator of the sprayer 1 may depress the trigger 204 to permit fluid to flow through the wand assembly 200.

In embodiments in which the wand assembly 200 is detached from the base fluid outlet line second end 64 and the base fluid outlet line 60 is connected to a power tool using a quick connector, such connector may include a normally closed internal valve that is mechanically opened upon secure connection of the base fluid outlet line connector 65 to the power tool. In addition, the power tool may include an internal valve that controls fluid flow through a fluid passageway of the tool.

Referring again to FIGS. 3 and 5, the base assembly 10 includes a back frame 300 that is connected to the housing 12 and the supply tank 50. The back frame 300 is used to convey the sprayer between use locations. In the illustrated embodiment, the back frame 300 serves as a wheeled cart that permits the sprayer 1 to be easily moved from place to place. In addition, the back frame 300 stably supports the base assembly 10 (and thus also the supply tank 50) on the ground.

The back frame 300 includes a support plate 302 having a front surface 303 that faces the sprayer 1, a rear surface 304 opposed to the front surface 303 and a relatively narrow peripheral surface 305 that extends between the broad front and rear surfaces 303, 304. The back frame 300 includes cylindrical sleeve 306 that extends along a lower portion of the peripheral surface 305. The sleeve 306 receives and supports a wheel axle 307 therethrough. A wheel 308 is joined to each of opposed ends of the axle 307, and wheels 308, 308 support the support plate 302 relative to the ground. An upper portion of the peripheral surface 305 is formed into a cart handle 309.

The front surface 303 of the support plate 302 includes a wedge-shaped protrusion 310 that is configured to secure the sprayer 1 to the back frame 300. The protrusion 310 is linear and elongated in a direction perpendicular to the wheel axle 307. The protrusion 310 has a uniform cross-sectional shape in a direction perpendicular to the wheel axle 307. In addition, the protrusion 310 tapers in a direction perpendicular to the front surface 303, so as to be most narrow at a location spaced apart from the front surface 303. The protrusion 310 is of sufficient length in a direction perpendicular to the wheel axle 307 to engage recesses 22, 70 provided in the rear surfaces of each of the base assembly 10 and the supply tank 50. Since the wheels 308, 308 are disposed along a lower rear edge of the base assembly 10, the base assembly housing 12 may include a pair of feet 311, 311 that support a lower front edge of the housing 12 when the back frame 300 is not in use. While in use, the back frame 300 supports the sprayer 1 and permits the sprayer 1 to be pulled or pushed along a ground surface by a user of the sprayer 1.

Referring to FIG. 9, operation of the sprayer 1 is as follows.

In step 500, when the on/off switch 42 is in the ‘off’ position, no energy is provided to controller 36 or other electrical components (e.g., the motor 26, the pressure sensor 34, the BMS 41, etc.) of the sprayer 1 by the battery 40 and the sprayer 1 is not operational (step 501).

If the on/off switch 42 is in the ‘on’ position, energy is provided to the controller 36 and other electrical components of the sprayer 1 (step 502). The controller 36 can then receive information from the BMS 41 such as SOC information and display that information on the display/HMI 46. In addition, the controller 36 can receive information from the pressure sensor 34. The motor 26 receives power from the battery 40 and drives the pump 30 to draw fluid from the supply tank 50 and supply it to the base fluid outlet line 60.

In step 503, after the controller 36 and pressure sensor 34 receive energy from the battery 40, the pressure sensor 34 outputs a detected pressure P_{D} to the controller 36. The controller 36 compares the detected pressure P_{D} to a predetermined threshold pressure P_{T}. In particular, the controller determines whether the detected pressure P_{D} is equal to or greater than the threshold pressure P_{T}. The threshold pressure P_{T} may be, for example, in a range of 80 psi to 135 psi. The specific threshold pressure PT is determined by the requirements of the specific application.

In step 504, if the wand assembly 200 is connected to the base assembly 10 via the base fluid outlet line 60, the control valve 266 of the handle 201 prevents fluid flow through the wand 202. The pressure in the pump fluid outlet line 32 increases since the control valve 266 is normally closed. When the pressure in the pump fluid outlet line 32 increases to a pressure that is greater than the threshold pressure P_{T}, the controller 36 stops power flow to the motor 26, which in turn stops operation of the pump 30.

If the trigger 204 of the wand assembly 200 is depressed, the control valve 266 opens and fluid is permitted to flow through the wand 202 and exit the nozzle 203. In this situation, the pressure in the pump fluid outlet line 32 decreases and P_{D} becomes less than P_{T}. The controller 36 continues to compare the detected pressure P_{D} to the threshold pressure P_{T} and as long as the pressure in the pump fluid outlet line 32 remains at or below the threshold pressure P_{T}, the pump 30 continues to deliver fluid to the wand assembly 200.

If the base fluid outlet line 60 is connected to a power tool via a quick connector, the fluid control mechanism of the connector permits fluid to flow to the power tool upon connection. However, the power tool may include an internal valve that controls fluid flow through the tool. If the internal valve is opened, the pressure in the pump fluid outlet line 32 remains below the threshold pressure P_{T}. In this case, the pump drives fluid to flow through the power tool.

Upon release of the trigger in the case of both the wand assembly 200 and the power tool, the pressure in the pump fluid outlet line 32 increases to a pressure that is greater than the threshold pressure P_{T}, and the controller 36 stops power flow to the motor 26, which in turn stops operation of the pump 30.

If the base fluid outlet line 60 is not connected to the base assembly 10, the detected pressure P_{D} will less than the threshold pressure P_{T}, for example zero. In this case, the motor and pump are allowed to operate until the reservoir 51 of the supply tank 50 is empty.

Thus, in the sprayer 1, the fluid pressure sensor 34 is configured to detect the fluid pressure of the pump fluid outlet line 32 and output a fluid pressure signal corresponding to the detected fluid pressure P_{D} to the controller 36. In addition, the controller 36 receives the fluid pressure signal and is configured to activate the motor 26 based on the detected fluid pressure.

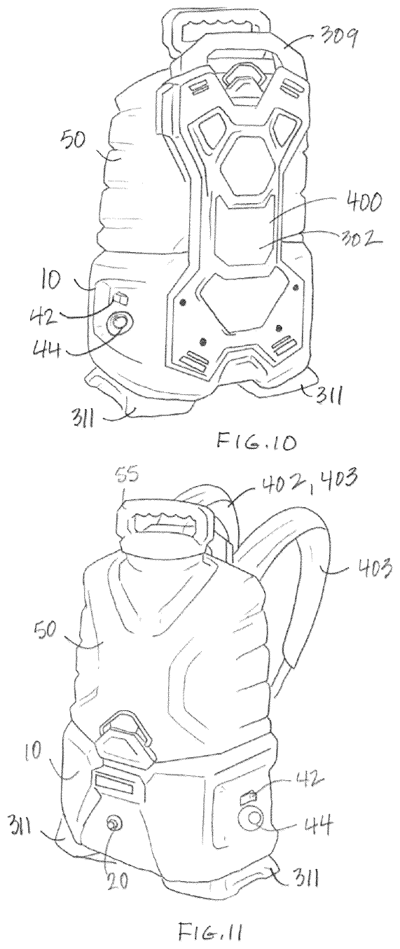

Referring to FIGS. 10 and 11, an alternative embodiment back frame 400 is similar to the back frame 300 shown in FIGS. 2 and 3 and common reference numbers are used to refer to common elements. The back frame 400 differs from the embodiment shown in FIGS. 2 and 3 since the sleeve 306, wheel axle 307 and wheels 308, 308 are omitted and rear surface 304 of the support plate 302 is provided with a flexible harness 402 including adjustable-length and padded shoulder straps 403, 403. By this configuration the back frame 400 provides a backpack that permits the sprayer 1 to be worn on a body of a user and carried by the shoulders of the user during transport.

In the illustrated embodiments, the supply tank 50 has a tank outlet opening 59 in a lower surface thereof that permits fluid communication between the reservoir 51 and the pump fluid inlet line 31 that is disposed in the base assembly 10. However, the sprayer 1 is not limited to this configuration. For example, in some embodiments, the supply tank 50 may have a tank outlet opening that is located on the upper backside thereof. In this example, the fluid lines that extend between the tank outlet opening and the pump fluid inlet line 31 may be disposed within the wedge-shaped protrusion 310 that used to secure the sprayer 1 to the back frame 300.

Although in the illustrated embodiment, the sprayer 1 employs a pressure sensor 34 in the base assembly 10, the sprayer 1 is not limited to including a pressure sensor 34. In other embodiments, for example, the sprayer 1 may include a pressure switch.

Selective illustrative embodiments of a portable power sprayer are described above in some detail. It should be understood that only structures considered necessary for clarifying the portable power sprayer have been described herein. Other conventional structures, and those of ancillary and auxiliary components of the portable power sprayer are assumed to be known and understood by those skilled in the art. Moreover, while working examples of the portable power sprayer have been described above, the portable power sprayer is not limited to the working examples described above, but various design alterations may be carried out without departing from the device as set forth in the claims.

What is claimed:

1. A portable liquid sprayer, the sprayer comprising:
a base assembly configured to be connected to a base fluid outlet line, and
a supply tank that is configured to store a liquid to be sprayed, the supply tank being detachably coupled to and supported on the base assembly,
wherein
the base assembly comprises:
a housing;
a motor disposed in the housing;
a battery disposed in the housing, the battery configured to supply power to the motor;
a pump disposed in the housing, the pump configured to be driven by the motor and output fluid to the base fluid outlet line via a pump fluid outlet line that is disposed inside the housing;
a pressure sensor configured to detect a fluid pressure of the pump fluid outlet line and output a fluid pressure signal corresponding to the detected fluid pressure, and
a controller that is configured to receive the fluid pressure signal and to activate the motor based on the detected fluid pressure.

2. The sprayer of claim 1, comprising a base fluid outlet line, wherein the base fluid outlet line includes:
a first end that connects to the base assembly and a second end that is opposed to and spaced apart from the first end,
wherein the second end of the base fluid outlet line comprises a wand assembly that receives fluid from the supply tank via the base fluid outlet line and is configured to selectively spray the received fluid.

3. The sprayer of claim 1, comprising a base fluid outlet line, wherein the base fluid outlet line includes:
a first end that connects to the base assembly and a second end that is opposed to and spaced apart from the first end,
wherein the second end of the base fluid outlet line terminates in a quick connect mechanical fluid connector.

4. The sprayer of claim 1, wherein the housing includes an opening and a fitting mounted in the opening, the fitting configured to provide a fluid connection between the base fluid outlet line and the pump outlet line.

5. The sprayer of claim 1, wherein the controller is configured to receive the fluid pressure signal from the pressure sensor, and
when the detected fluid pressure is less that a predetermined pressure, the controller permits power to be supplied to the motor and the pump is driven by the motor, and
when the detected fluid pressure is greater than the predetermined pressure, the controller prevents power from being supplied to the motor and the pump is not driven by the motor.

6. The sprayer of claim 1, wherein the supply tank is connected to the pump via a pump fluid inlet line that is disposed in the base assembly.

7. The sprayer of claim 1, wherein the battery is removably coupled to the base assembly.

8. The sprayer of claim 1, wherein the sprayer is configured so that a user-operated power switch mounted on an outer surface of the housing determines a connection between the motor and the battery, and
when the power switch is in an on position, the motor is operable to drive the pump based on the detected fluid pressure, and when the power switch is in an off position, the motor is not operable.

9. The sprayer of claim 1, comprising a display, wherein
the controller is configured to monitor the state of charge of the battery, and to output a control signal to the display corresponding to the state of charge of the battery, and
the display is configured to display a representation of the state of charge of the battery based on the control signal.

10. The sprayer of claim 1, comprising a selector device that is mounted on the housing so as to permit manipulation by a user of the sprayer, wherein
the selector device is electrically connected to the controller, and
the controller is configured to control the speed of the motor based on a configuration of the selector device.

11. The sprayer of claim 1, wherein the base assembly comprises a back frame that is connected to the housing, the back frame configured to convey the sprayer between use locations.

12. The sprayer of claim 11, wherein the back frame is configured to be converted between a first use mode and a second use mode,
the first use mode comprising a harness configuration, and the sprayer includes a harness that can be worn on a body of a user of the sprayer, and
the second use mode comprising a wheeled cart configuration, and the sprayer includes a wheeled card assembly that can be pulled or pushed along a ground surface by a user of the sprayer.
